(19) United States
(12) Patent Application Publication
(10) Pub. No.: US 2017/0308090 A1
(43) Pub. Date: Oct. 26, 2017

(54) VEHICLE CONTROL SYSTEM, VEHICLE CONTROL METHOD AND VEHICLE CONTROL PROGRAM

(71) Applicant: Honda Motor Co.,Ltd., Tokyo (JP)

(72) Inventor: Masahiko ASAKURA, Saitama (JP)

(73) Assignee: Honda Motor Co.,Ltd., Tokyo (JP)

(21) Appl. No.: 15/488,529

(22) Filed: Apr. 17, 2017

(30) Foreign Application Priority Data
Apr. 26, 2016 (JP) 2016-088260

(51) Int. Cl. G05D 1/02; B60W 30/12; G05D 1/00; G01C 21/34; B60W 10/04; B60W 10/20; B60W 30/18; G01S 19/13

(52) U.S. Cl. CPC G05D 1/0217; B60W 10/20; B60W 30/12; B60W 30/18163; G05D 1/0088; G01C 21/3469; B60W 10/04; B60W 2420/42; B60W 2420/52; B60W 2520/14; B60W 2710/20; B60W 2720/10; G01S 19/13; B60W 2520/105

(57) ABSTRACT

One of objectives of the present invention is to derive a timing of energy supply in an automatic driving process with a better precision. A vehicle control system of the present invention comprises: an automatic driving control part, automatically performing at least one of velocity control and steering control of a vehicle, thereby automatically driving the vehicle to a set destination; a deriving part, deriving the energy predicted to be consumed during automatic driving on a guide path from a current position of the vehicle to the destination; and a judging part, judging whether the vehicle needs to be supplied with energy until the vehicle arrives at the destination based on the energy derived by the deriving part.

### CROSS-REFERENCE TO RELATED APPLICATION

This application claims the priority benefit of Japan application serial no. 2016-088260, filed on Apr. 26, 2016. The entirety of the above-mentioned patent application is hereby incorporated by reference herein and made a part of this specification.

### BACKGROUND OF THE INVENTION

### 1. Field of the Invention

The present invention relates to a vehicle control system, a vehicle control method and a vehicle control program.

### 2. Description of Related Art

In recent years, research on at least one of technologies (called as automatic driving hereinafter) in acceleration and deceleration and steering for automatically controlling vehicles is being promoted. Relatively, there is a known navigation device, characterized by calculating a consumption of driving energy during driving on any link contained in map information, and calculating a recommended path in the paths of which a residue of the driving energy of the vehicles is not lower than a prescribed threshold value and having a least cost based on the residue of the driving energy and the residue of the driving energy of the vehicles (for example with reference to patent document 1).

### EXISTING TECHNICAL DOCUMENTS

### Patent Document

Patent document 1: Japanese Patent No. 2011-075382

### SUMMARY OF THE INVENTION

### Problem to be Solved by the Invention

But, in conventional technologies, according to a road condition during driving, even though as a path deteiiiiined as a recommended path, it is possible that energy needs to be supplied in a driving process sometimes.

The present invention is finished in consideration of this situation, and one of its objectives is to derive a timing of energy supply in an automatic driving process with a better precision.

### Technical Means Solving the Problem

The invention according to claim 1 is a vehicle control system, comprising an automatic driving control part, automatically performing at least one of velocity control and steering control of a vehicle, thereby automatically driving the vehicle to a set destination; a deriving part, deriving the energy predicted to be consumed during automatic driving on a guide path from a current position of the vehicle to the destination; and a judging part, judging whether the vehicle needs to be supplied with energy until the vehicle arrives at the destination based on the energy derived by the deriving part.

The invention of claim 2 is the vehicle control system according to claim 1, which further comprises: an information providing part, providing infomiation for a vehicle passenger when the judging part judges that the vehicle needs to be supplied with energy.

The invention of claim 3 is the vehicle control system according to claim 1 or 2, wherein the automatic driving control part executes one of multiple modes in which the energy consumptions of the vehicle are different so as to automatically perform at least one of the velocity control and steering control of the vehicle, and executing a burnup inhibition mode in which the energy consumption is less than that of the mode being executed in the multiple modes when the judging part judges that the vehicle needs to be supplied with energy.

The invention of claim 4 is the vehicle control system according to claim 3, wherein the deriving part derives the energy predicted to be consumed during burnup inhibition when the automatic driving control part executes the bumup inhibition mode, and the judging part further judges whether the vehicle needs to be supplied with energy based on the energy during burnup inhibition derived from the deriving part.

The invention of claim 5 is the vehicle control system according to claim 3 or 4, wherein when the judging part judges that the vehicle needs to be supplied with energy, the information providing part provides the information permitting to change the mode executed by the automatic driving control part into the burnup inhibition mode to the vehicle passenger, the automatic driving control part changes the executed mode into the burnup inhibition mode when the vehicle passenger permits to change into the burnup inhibition mode.

The invention of claim 6 is the vehicle control system according to any one of claims 1-5, which further comprises: a setting part, setting a location where an energy supply facility exists into a temporary destination, and the automatic driving control part causes the vehicle to automatically driving to the destination set by the setting part when the judging part judges that the vehicle needs to be supplied with energy.

The invention of claim 7 is the vehicle control system according to claim 6, which further comprises: an operation part, operated by the vehicle passenger, and the setting part decides a priority condition setting the temporary destination on priority based on an operation on the operation part, and sets the energy supply facility meeting the determined priority condition into the temporary destination.

The invention of claim 8 is the vehicle control system according to any one of claims 2-7, wherein when the information providing part provides prescribed information for the vehicle passenger if no energy supply facility exists around the guide path when the judging part judges that the vehicle needs to be supplied with energy.

The invention of claim 9 is a vehicle control method, by which a computer performs at least one of velocity control and steering control of a vehicle, thereby automatically driving the vehicle to a set destination, derives the energy predicted to be consumed during automatic driving on a guide path from a current position of the vehicle to the destination, and judges whether the vehicle needs to be supplied with energy until the vehicle arrives at the destination based on the derived energy.

The invention of claim 10 is a vehicle control program, enabling a computer to perform following processing: that is, automatically performing at least one of velocity control and steering control of a vehicle, thereby automatically driving the vehicle to a set destination; deriving the energy predicted to be consumed during automatic driving on a guide path from a current position of the vehicle to the destination; and judging whether the vehicle needs to be supplied with energy until the vehicle arrives at the destination based on the derived energy.

### Effects of the Invention

The invention according to respective claims, a timing of energy supply in an automatic driving process can be derived with a better precision.

### BRIEF DESCRIPTION OF THE DRAWINGS

FIG. 1 is a diagram illustrating constitution devices of an own vehicle M.

FIG. 2 is a function structural diagram aking a vehicle control system 100 as a center.

FIG. 3 is a structural diagram of HMI70.

FIG. 4 is a diagram illustrating a condition that an own vehicle position recognizing part 140 recognizes a relative position of the own vehicle M relative to a traveling lane L1.

FIG. 5 is a diagram illustrating an example of an action plane generated in certain interval.

FIG. 6 is a diagram illustrating one example of a structure of a trajectory generation part 146 in a first embodiment.

FIG. 7 is a diagram illustrating an example of a trajectory candidate generated by a trajectory candidate generating part 146B.

FIG. 8 is a diagram illustrating a trajectory candidate generated by the trajectory candidate generating part 146B with a trajectory point K.

FIG. 9 is a diagram illustrating a lane change target position TA.

FIG. 10 is a diagram illustrating a velocity generating model when velocities of three peripheral vehicles are assumed to be fixed.

FIG. 11 is a diagram illustrating an example of a structure of an HMI control part 170.

FIG. 12 is a diagram illustrating an example of a mode differentiation operation yes/no information 185.

FIG. 13 is a diagram illustrating a structure of an energy monitoring part 190.

FIG. 14 is a diagram illustrating an example of a screen displayed under a scenario of needing energy supply.

FIG. 15 is a diagram illustrating an example of a screen displayed when an automatic driving mode is permitted to last in order for energy supply.

FIG. 16 is a diagram for explaining a setting method of a temporary destination for meeting a priority condition of supply times.

FIG. 17 is a diagram for explaining a setting method of a temporary destination for meeting a priority condition of playing time.

FIG. 18 is a diagram for explaining a setting method of a temporary destination for meeting a priority condition of price.

FIG. 19 is a diagram for explaining a setting method of a temporary destination corresponding to an energy supply moment designated at each moment.

FIG. 20 is a flow chart illustrating an example of a flow of processing performed by a vehicle control system 100 in the first embodiment.

FIG. 21 is a diagram of an example of a structure of a trajectory generation part 146# in a second embodiment.

FIG. 22 is a diagram illustrating selection of an example of a screen of a burnup mode.

FIG. 23 is a diagram illustrating an example of a controlcondition of each burnup mode.

FIG. 24 is a diagram for explaining a trajectory inter-point distance D_{K(i)-K(i+1)} and a steering angle φi.

FIG. 25 is a diagram illustrating an example of a screen for requesting to permit to change, the burnup mode.

FIG. 26 is a flow chart illustrating an example of a flow of processing performed by a vehicle control system 100 in a second first embodiment.

### DESCRIPTION OF THE EMBODIMENTS

Hereinafter, embodiments of the vehicle control system, the vehicle control method and the vehicle control program of the present invention are explained with reference to drawings.

<Shared Structure>

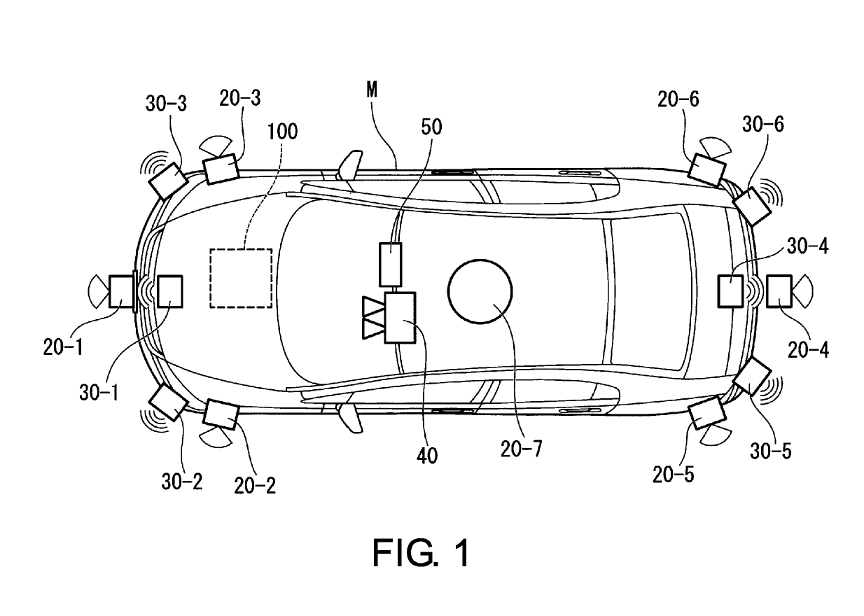

FIG. 1 is a diagram of constitution devices of a vehicle (short for the own vehicle M) carrying a vehicle control system 100 of respective embodiments. The vehicle carrying the vehicle control system 100 for example is a two-wheel, three-wheel or four-wheel vehicle, including a vehicle taking a diesel engine or gasoline engine as an internal combustion engine as power energy, an electric vehicle taking an electromotor as a power source, a hybrid vehicle having both the internal combustion engine and the electromotor, etc. The electric vehicle for example is driven by electricity released from a secondary battery, a hydrogen fuel battery, a metal fuel battery, an alcohol fuel battery, and other batteries.

As shown in FIG. 1, the own vehicle M carries sensors such as finders 20-1 to 20-7, radars 30-1 to 30-6, a camera 40, a navigation device 50 and a vehicle control system 100.

The finders 20-1 to 20-7 for example detect the scattering light relative to irradiating light, so as to detect a distance from LIDAR (Light Detection and Ranging) or Laser Imaging Detection and Ranging of a distance to an object. For example, the finder 20-1 is mounted on a front grill, etc., the finder 20-2 and finder 20-3 are mounted on a side surface or door mirror, inside a headlamp or nearby a side lamp, etc. The finder 20-4 is mounted on a trunk lid, etc., and the finder 20-5 and the finder 20-6 are mounted at the side surface of a vehicle body or inside a taillight, etc. The finders 20-1 to 20-6 for example have a detection region of about 150 degrees in the horizontal direction. Besides, the finder 20-7 is mounted on a vehicle roof, etc. The detector 20-7 for example has a detection region of 360 degrees in the horizontal direction.

The radar 30-1 and radar 30-4 for example are long distance millimetre wave radars of which the detection region in a depth direction is longer than other radars. Besides, the radars 30-2, 30-3, 30-5 and 30-6 are middle distance millimetre wave radars of which the detection region is shorter than the radars 30-1 and radar 30-4 in a depth direction.

Hereinafter, under the condition of not being particularly distinguished, the finders 20-1 and 20-7 are short for “radar 20”, under the condition of not being particularly distinguished, the radars 30-1 to 30-6 are short for radar 30. The radar 30 for example detects an object in a Frequency Modulated Continuous Wave (FM-CW) manner.

The camera 40 for example uses a digital camera using a solid camera device such as a Charged Coupled Device (CCD) or Complementary Metal Oxide Semiconductor (CMOS). The camera 40 is mounted on the upper part of a front window 90a at the front surface of a vehicle or on the back surface of a vehicle room mirror. The camera 40 for example periodically repeatedly photographs a position in front of the own vehicle M. The camera 40 can be also a stereo camera containing multiple cameras.

In addition, the structure as shown in FIG. 1 is only an example, that is, part of the constitution can be omitted or other structures can be further added.

### First Embodiment

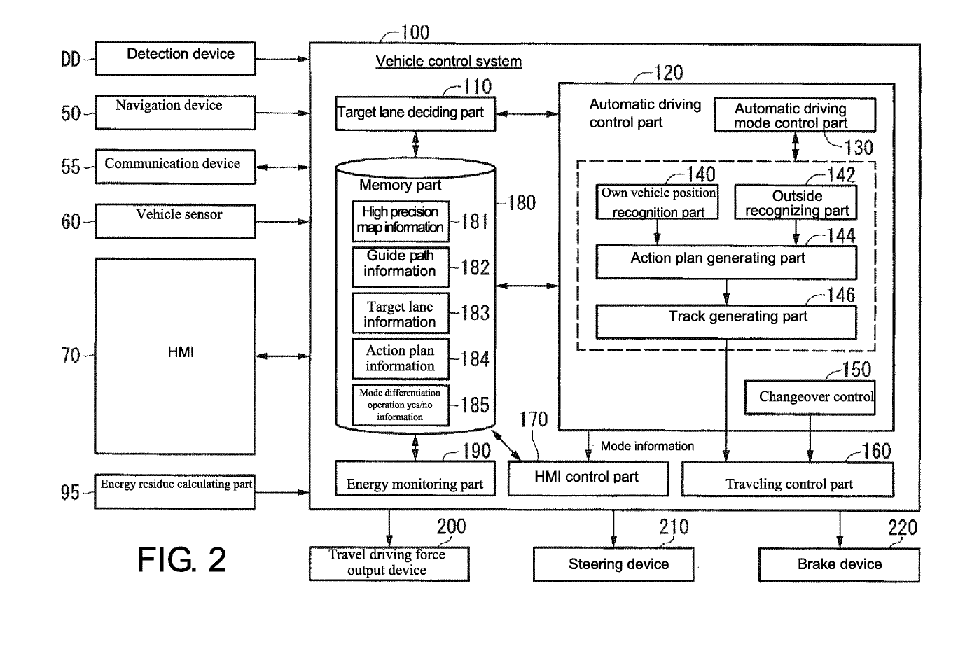

FIG. 2 is a function structure diagram taking the vehicle control system 100 of the embodiment as a center. The own vehicle M carries a detection device (DD) containing a finder 20, a radar 30, a camera 40, etc., a navigation device 50, a communication device 55, a vehicle sensor 60, a Human Machine Interface (HMI) 70, an energy residue calculating part 95, a vehicle control system 100, a travel driving force output device 200, a steering device 210 and a brake device 220. These devices or equipments are connected to one another by a multiplexing communication line such as a Controller Area Network (CAN), or a serial communication line, a wireless communication network, etc. In addition, the vehicle control system in claims is not only referred to “the vehicle control system 100”, but also comprises the constitution (finder DD or HMI 70) except for “vehicle control system 100”.

The navigation device 50 has a Global Navigation Satellite System (GNSS) receiver or map information (navigation map), and a touch panel display device playing a role as a user interface, a speaker, a microphone, etc. The navigation device 50 determines the position of the own vehicle M by the GNSS receiver, and derives a path for guiding the own vehicle M from such position to the destination designated by a vehicle passenger (short for guide path hereinafter). Besides, the navigation device 50 can also derive a path from a position (for example, a nearest station, etc.) designated by the vehicle passenger instead of the position of the own vehicle M to the destination as the guide path.

For example, the navigation device 50 takes the current position of the own vehicle M or any position designated by the vehicle passenger as a guide start location for processing, and evaluates multiple path candidates from the guide start location to a guide end location as the destination according to prescribed evaluation conditions respectively. The prescribed evaluation conditions are: the shortest traveling time or traveling distance, the lowest prices of a charging road and the like, being an express way, etc. Such prescribed evaluation conditions can be freely changed according to an operation of the vehicle passenger. For example, when judging consistency of the evaluation conditions, the navigation device 50 uses a quantity of supply facilities, traveling time, traveling distance, existence of the charging rod, tolls and the like to evaluate the multiple candidate pats respectively. The so-called energy supply facility for example is a facility, such as a gas station of charging station, which can supply energy to driving a power source of the vehicle. For example, the energy supply facilities existing in a prescribed range from the path candidates as an evaluated object are counted as the energy supply facilities of the path candidates. The so-called energy supply facilities existing in the prescribed range for example refer to the energy supply facilities along a road shown by the path candidates as the evaluated object.

Besides, the navigation device 50 derives the path candidate consistent with the prescribed evaluation condition in the path candidates and having a highest comprehensive evaluation in consideration of all evaluation items or the path candidate having the highest path candidate relative to part of evaluation items as the guide path. In addition, the evaluation conditions can be weighted through operation of the vehicle passenger. For example, the path candidate with the shorter traveling time is derived as the guide path in more priority for weighting, or the path candidate with a larger quantity of energy supply facilities is derived as the guide path in more priority for weighting.

The navigation device 50 outputs information representing the derived guide path to the vehicle control system 100. In addition, the information representing the guide path can also contain the information representing the path candidate not selected as the guide path but for example evaluated to be the second or third. The information representing the guide path is stored in a storage part 180 of the vehicle control system 100 mentioned below as guide path information 182.

Besides, the navigation device 50 for example can determine or replenish the position of the own vehicle M by using an Inertia Navigation System (INS) output by using a vehicle sensor 60. Besides, the navigation device 50 can guide through a sound or navigation display for the path to the destination when the vehicle control system 100 execute a manual driving mode. In addition, the structure for determining the position of the own vehicle M or the structure for evaluating the path candidates can be set independent from the navigation device 50. Besides, the navigation device 50 for example can be realized through functions of a terminal device such as a smartphone or tablet terminal held a user. At this point, the terminal device and the vehicle control system 100 can receive and send information based on wireless or wired communication.

The communication device 55 for example performs wireless communication using a cellular net or a Wireless Fidelity (Wi-Fi) net, Bluetooth (registered trademark), Dedicated Short Range Communication (DSRC), etc. For example, the communication device 55 wirelessly communicates with a server for information provision of a system for monitoring a traffic condition of a road such as a Vehicle Information and Communication System (VICS) (registered trademark), to obtain information (short for traffic information hereinafter) representing the traffic condition of a driving road of the own vehicle M or the traffic condition of a prescribed driving road. The traffic information contains front congestion information, required time of a congestion location, accident/failed vehicle/construction information, velocity limitation/lane restriction information, positions of parking lots, full vehicle/empty vehicle information of the parking lot/service area/parking area, and the like. Besides, the communication device 55 can communicate with a wireless beacon in a lateral area of the road side, or performs vehicle-vehicle communication with other vehicles driven around the own vehicle M, thereby obtaining the traffic information. Besides, the communication device 55 can investigate an energy price of each energy supply facility and communicate with a server providing information by investigation to obtain info iation relates to the energy price.

The vehicle sensor 60 contains a vehicle velocity sensor detecting a vehicle velocity, an acceleration sensor detecting an acceleration, a yaw rate sensor detecting an angular velocity around a plumb axis, a direction sensor detecting a direction of the own vehicle M, and the like.

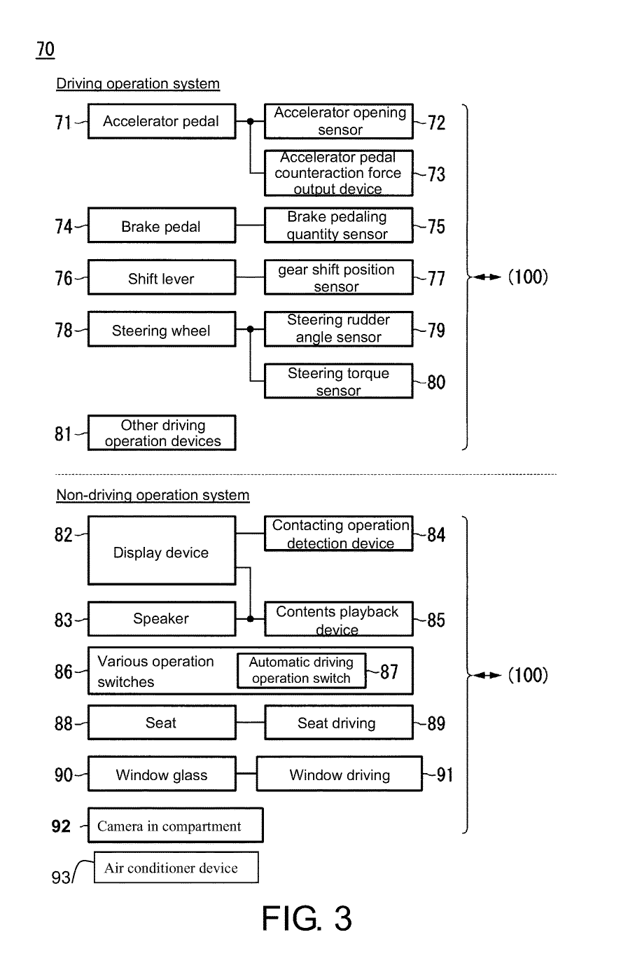

FIG. 3 is a structural diagram of an HMI70, which for example has a structure of a driving operation system and a structure of a non-driving operation system. Their boundaries are unclear, and the structure of the driving operation system can also have functions of the non-driving operation system (or vice versa).

As the structure of the driving operation system, the HMI70 for example contains an accelerator pedal 71, an acceleration opening sensor 72, an accelerator pedal counteraction force output device 73, a brake pedal 74, a brake pedalling quantity sensor (or main pressure sensor, etc.) 75, a shift lever 76, a gear sensor 77, a steering wheel 78, a steering rudder angle sensor 79, a steering torque sensor 80 and other driving operation devices 81.

The accelerator pedal 71 is an operation device used for accepting an acceleration indication (or deceleration indication based on a recovery operation). The acceleration opening sensor 72 detects a pedalling quantity of the accelerator pedal 71, and outputs an accelerator opening signal expressing the pedalling quantity to the vehicle control system 100. In addition, the output to the vehicle control system 100 can be replaced with the direct output to the travel driving force output device 200, the steering device 210 or the brake device 220. The constitution of other driving operation systems explained hereinafter is also the same. The accelerator pedal counteraction force output device 73, for example according to the indication from the vehicle control system 100, outputs a force (operation counteraction force) in a direction opposite to an operation direction relative to the accelerator pedal 71.

The brake pedal 74 is an operation device used for accepting a deceleration indication of the vehicle passenger. The brake pedalling quantity sensor 75 detects the pedalling quantity (or pedalling force) of the brake pedal 74, and outputs a brake signal expressing a detection result to the vehicle control system 100.

The gear lever 76 is an operation device used for accepting a change indication of a shift stage based on the vehicle passenger. The gear sensor 77 detects a gear indicated by the vehicle passenger and outputs a gear signal expressing the detection result to the vehicle control system 100.

The steering wheel 78 is an operation device for accepting a steering indication of the vehicle passenger. The steering rudder angle sensor 79 detects an operation angle of the steering wheel 78 and outputs a steering rudder signal expressing the detection result to the vehicle control system 100. The steering torque sensor 80 detects a torque applied to the steering wheel 78 and outputs a signal expressing a steering torque signal of the detection result to the vehicle control system 100.

Other driving operation devices 81 comprise such as a joystick, a button, a dial switch, a Graphic user Interface (GUI) switch, etc. Other driving operation devices 81 accept the acceleration indication, the deceleration indication, the steering indication, etc., and output to the vehicle control system 100.

As the structure of the non-driving operation system, the HMI70 for example contains a display device 82, a speaker 83, a contacting operation detection device 84 and a contents playing device 85, various operation switches 86, a seat 88, a seat driving device 89, window glass 90, a window driving device 91, a camera in compartment 92 and an air conditioner device 93. The structure of the non-driving operation system of the HMI70 is one example of the “operation part”.

The display device 82 for example is a Liquid Crystal Display (LCD) or Electroluminescence (EL) display device, etc., mounted on each part of an instrument panel, a co-passenger seat or any position opposite to a rear seat. Besides, the display device 82 can be a Head Up Display (HUD) projecting an image to the front windshield or other windows. The speaker 83 outputs a sound. The contacting operation detection device 84 detects a contacting position (touch position) on a display screen of the detection device 82 under a condition that the display device 82 is a touch screen and outputs to the vehicle control system 100. In addition, under the condition that the display device 82 is a non-touch display screen, the contacting operation detection device 84 can be omitted.

The contents playing device 85 for example contains a Digital Versatile Disc (DVD), a playback device, a Compact Disc (CD) playback device, a television receiver, a generation device of various guide devices, etc. Part or all of the display device 82, the speaker 83, the contacting operation detection device 84 and the contents playing device 85 can also be a structure shared with the navigation device 50.

Respective operation switches 86 are configured in any positions in a compartment and contain an automatic driving changeover switch 87 indicating starting (or starting in the future) and stopping of the automatic driving. The automatic driving changeover switch 87 is any one of a GUI (Graphic User Interface) switch and a mechanical switch. Besides, the respective operation switches 86 can also contain a switch for driving the seat driving device 89 or the window driving device 91.

The seat 88 is a seat seated by the vehicle passenger. The seat driving device 89 for example drives the seat 88 from a reclining angle, a front and back direction position, a deflection angle, etc. . . . The window glass 90 for example is disposed on each vehicle door. The window glass driving device 91 opens, closes and drives the window glass 90.

The camera in compartment 92 is a digital camera using a solid camera device such as a CCD or CMOS. The camera in compartment 92 is mounted in a position where at least the head of the vehicle passenger who drives can be photographed, such as a back mirror or a steering boss part, an instrument panel, etc. The camera 40 for example periodically repeatedly photographs the vehicle passenger. The air conditioner device 93 adjusts a temperature or humidity or air volume in a compartment.

The energy residue calculating part 95 calculates the residue of the energy driving a power source of the own vehicle M. For example, the energy residue calculating part 95 calculates the residue of a liquid fuel such as gasoline burning in an internal combustion engine when the own vehicle M is a vehicle taking the internal combustion engine as the power source. Besides, the energy residue calculating part 95 calculates the residue of a battery output power driving an electromotor when the own vehicle M is a vehicle taking the electromotor as the power source. Besides, the energy residue calculating part 95 calculates the residue of both the liquid fuel and the battery when the own vehicle M is a hybrid vehicle having both the internal combustion engine and the electromotor. The energy residue calculating part 95 outputs the information representing the calculated energy residue to the vehicle control system 100.

Before the vehicle control system 100 is explained, the travel driving force output device 200, the steering device 210 and the brake device 220 are explained.

The travel driving force output device 200 is used for outputting a travel driving force (torque) for the vehicle to driving wheels. The travel driving force output device 200 for example has an engine, a transmission and an engine Electronic Control Unit (ECU) controlling the engine when the own vehicle M is a vehicle taking the internal combustion engine as a power source, has a motor for driving and a motor ECU controlling the motor for driving when the own vehicle M is an electric vehicle taking the electromotor as a powersource and has an engine, a transmission, an engine ECU, a motor for driving and a motor ECU when the own vehicle M is a hybrid vehicle. Under the condition that the travel driving force output device 200 only contains the engine, the engine ECU adjusts a throttle opening or gear according to information input from a later traveling control part 160. Under the condition that the travel driving force output device 200 only comprises the motor for driving, the motor ECU adjusts a duty ratio of a Pulse Width Modulation (PWM) signal given to the motor for driving according to the information input from the traveling control part 160. Under the condition that travel driving force output device 200 only comprises the engine and the motor for driving, the engine ECU and the motor ECU control a travel driving force harmonically according to the information input from the traveling control part 160.

The steering device 210 for example has a steering ECU and an electromotor. The electromotor for example changes the direction of a steering wheel by acting a force on a rack and pinion mechanism. The steering ECU drives the electromotor according to the information input from the vehicle control system 100 or input steering rudder angle or steering torque information so as to change a direction of the steering direction.

The brake device 220 for example is an electric servo rake device having a brake calliper, a cylinder transmitting a hydraulic pressure to the brake calliper, an electromotor enabling the cylinder to generate the hydraulic pressure and a brake control part. The brake control part of the electric servo brake device controls the electromotor according to the information input from the traveling control part 160 so as to output a brake torque corresponding the brake operation to each wheel. The electric servo brake device has a mechanism transmitting the hydraulic pressure generated by the operation of the brake pedal to the cylinder through a master cylinder as a backup. In addition, the brake device 220 is not limited to the explained electric servo brake device and can also be an electronic control type hydraulic brake device. The electronic control type hydraulic brake device controls an actuator according to the information input from the traveling control part 160 to transmit the hydraulic pressure of the master cylinder to the cylinder. Besides, the brake device 200 can also contain a regenerative brake, which uses the motor for driving contained in the travel driving force output device 200.

[Vehicle Control System]

The vehicle control system 100 is explained hereinafter. The vehicle control system 100 for example is realized by more than one processor or hardware having the same functions. The vehicle control system 100 can be a structure formed by constituting processor such as a Central Processing Unit (CPU), an ECU (electronic Control unit) formed by connecting a memory device and a communication port through an internal bus or a Micro-Processing Unit (MPU).

Back to FIG. 2, the vehicle control system 100 for example has a target lane determination part 110, an automatic driving control part 120, a traveling control part 160, HMI control part 170, a storage part 180 and an energy monitoring part 190. The automatic driving control part 120 for example has an automatic driving mode control part 130, an own vehicle position recognizing part 140, an outside recognizing part 142, an action plan generating part 144, a trajectory generation part 146 and a changeover control part 150.

Each part in the target lane determination part 110, the automatic driving control part 120 and part or all of the traveling control part 160 can be realized by hardware such as a Large Scale Integration (LSI) or an Application Specific Integrated Circuit (ASIC), and can also be realized by combining software with hardware.

In the storage part 180, for example, stores information such as high precision map information 181, guide path information 182, target lane information 183, action plan information 184, mode differentiation operation yes/no information 185, etc. The storage part 180 is realized by using a Read Only Memory (ROM) or a Random Access Memory (RAM), a Hard Disc Drive (HDD), a flash memory, etc. A program executed by the processor can be prestored in the storage part 180 and can also be downloaded from an external device tluough a vehicle-mounted international Internet device, etc. Besides, the program can also be installed in the storage part 180 by mounting a portable memory medium storing such program nto an unshown drive device. Besides, the vehicle control system 100 can be dispersed through a plurality of computer devices.

The target lane determination part 110 for example is realized by an MPU. The target lane determination part 110 divides a guide path into a plurality of blocks with reference to the guide path information 182 output from the navigation device 50. The target lane determination part 110 for example divides the guide path every 100 [m] about a vehicle advancing direction. Besides, the target lane determination part 110 decides the target lane where the own vehicle M is driven in the guide path divided into all blocks by referring to the high precision map information 181. The target lane determination part 110 for example makes a decision of driving from which lane on the left. The target lane determination part 110 for example decides the target lane in a manner hat the own vehicle M can be driven in a reasonable traveling path advancing to a fork road under a condition that a fork road or converging part exists in the path. The target lane determined by the target lane determination part 110 takes the determined target lane as the target lane information 183 to store in the storage part 180.

The high precision map information 181 is map information of which the precision is higher than that of a navigation map of the navigation device 50. The high precision map information 181 for example comprises central information of a lane, or boundary information of the lane. Besides, the high precision map information 181 can contain road information, traffic limitation information, residence information (residence and post code), facility information, telephone number information, etc. The road information contains information expressing road variety such as an express way, toll road, national road and country road; or information such as a road lane number, a width of each lane, a slope of the road, road positions (three dimensional coordinates containing longitude, latitude and height), a curve curvature of the lane, a converging and fork point position of the lane, signs on the road, and the like. The traffic limitation information contains information that the lane is blocked due to construction or traffic accidents and congestion. The facility information can contain: information representing whether facilities existing on a high precision map are equivalent to the energy supply facilities; or information representing that the energy supply facilities can provide which energy such as gasoline, battery charging, hydrogen charging and the like.

The automatic driving mode control part 130 decides modes of automatic driving executed by the automatic driving control part 120. The modes of the automatic driving in the present embodiment contain the following modes. In addition, the following modes are only an example, and the mode number of the automatic driving can be freely determined.

[Mode A]

The mode A is the mode with the highest automatic driving mode. When the mode A is executed, all vehicle control is performed automatically, for example, complex converging control, therefore, the vehicle passenger does not need to monitor the peripheral or state of the own vehicle M.

[Mode B]

The mode B is a mode in which the automatic driving degree is second to the mode A. When the mode B is executed, all vehicle control is performed automatically on principle, but according to a scenario, the driving operation of the own vehicle M is relegated to the vehicle passenger. Therefore, the vehicle passenger must monitor the periphery or state of the own vehicle M.

[Mode C]

The mode C is a mode in which the automatic driving degree is second to the mode B. When the mode C is executed, the vehicle passenger must perform corresponding confirming operation corresponding to the scenario on the HMI70. In the mode C, for example, the vehicle passenger is informed of the lane change timing, when the vehicle passenger performs operation of changing the lane on the HMI70, automatic lane change is performed. Therefore, the vehicle passenger must monitor the periphery or state of the own vehicle M.

The automatic driving mode control part 130 decides the automatic driving mode based on the operation of the vehicle passenger on the HMI 70, an event determined by the action plan generating part 144 and a travel condition determined by the trajectory generation part 146. The automatic driving mode is informed to the HMI control part 170. Besides, in the automatic driving mode, a boundary corresponding to the performances of the DD of the own vehicle M can also be set. For example, if the performances of the DD are lower, then the mode A cannot be performed. Under any mode, the manual driving mode (override) can be switched specific to the operation of the structure of the driving operation system in the HM170.

The own vehicle position recognizing part 140 of the automatic driving control part 120 recognizes lane (traveling lane) where the own vehicle M is driven and a relative position of the own vehicle M relative to the traveling lane based on the high precision map information 181 stored in the storage part 180 and information input from the finder 20, the radar 30, the camera 40, the navigation device 50 or the vehicle sensor 60.

The own vehicle position recognizing part 140 for example compares a graph (for example arrangement of solid line and virtual line) of a road division line recognized from the high precision map information 181 with that of the road division line of the periphery of the own vehicle M recognized from an image photographed by the camera 40, and thus recognizes the traveling lane. In such recognizing, the position of the own vehicle M obtained from the navigation device 50 or a processing result based on INS can also be considered.

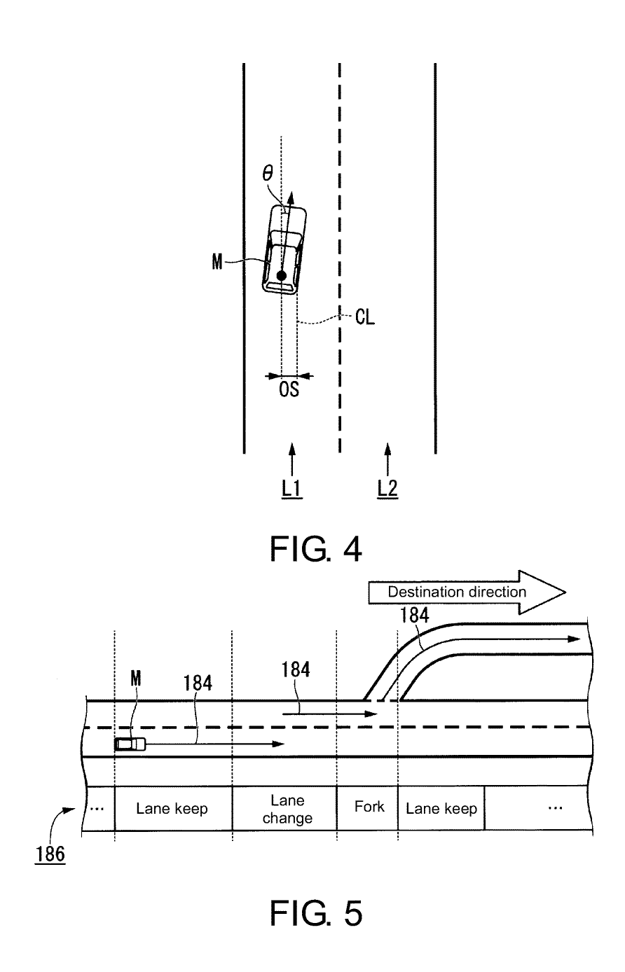

FIG. 4 is a diagram of condition that an own vehicle position recognizing part 140 recognizes a relative position of the own vehicle M relative to a traveling lane L1. The own vehicle position recognizing part 140 for example recognizes a deviation OS from a reference point (for example gravity center) of the own vehicle M to the central CL of the traveling lane and the angle θ between the advancing direction of the own vehicle M relative to a line connected to the central CL of the traveling lane as a relative position of the own vehicle M relative to the traveling lane L1. In addition, alternatively, the own vehicle position recognizing part 140 recognizes the position of the reference point of the own vehicle M relative of any side end part of the own lane L1 as a relative position of the own vehicle M relative to the traveling lane. The relative position of the own vehicle M recognized by the own position recognizing part 140 is provided for the target lane determination part 110.

The outside recognizing part 142 recognizes the position and velocity, the acceleration and other states of peripheral vehicles based on the information input from the finder 20, the radar 30 and the camera 40. The so-called peripheral vehicles for example are vehicles driven at the periphery of the own vehicle M and the vehicles driven in the direction same as the own vehicle M. The positions of the peripheral vehicles can be represented by representing points such as the gravity center or corner of other vehicles and can also be repressed by a region expressed by the profiles of other vehicles. The “state” of the peripheral vehicles can also contain the acceleration of the peripheral vehicles and whether the lane change is being performed (or whether the lane change is about to be performed) learned based on the information of various devices. Besides, the outside recognizing part 142 can also recognize the positions of a guardrail or a telegraph pole, a parked vehicle, a walker and other objects expect for the peripheral vehicles.

The action plan generating part 144 sets start location and/or a destination of the automatic driving. The start location of the automatic driving can be the current position of the own vehicle M or a location where the automatic driving operation is performed. The action plan generating part 144 generates an action plan for an interval between the start location and the destination of the automatic driving. In addition, the action plan generating part 144 is not limited thereto and can generate an action plan at any interval.

The action plan contains multiple events executed in sequence. The events for example contain a deceleration event decelerating the own vehicle M; or an acceleration event accelerating the own vehicle M; a lane keep event driving the own vehicle M in a manner of not deviating from the traveling lane; a lane change event changing the traveling lane; an overtaking event enabling the own vehicle M to overtake a preceding vehicle; a fork event changing the required lane at a fork point or driving the own vehicle M in a manner of not deviating from the current traveling lane; a converging event accelerating and decelerating the own vehicle Min a converging lane converged to a high street and changing the traveling lane; and a handover event converting the manual driving mode to the automatic driving mode at the start location of automatic driving or converting the automatic driving mode to the automatic driving mode at an ending predicted location of the automatic driving. The action plan generating part 144 sets the lane change event, the fork event or the converging event in a position of switching the target lane determined by the target lane determination part 110. The information expressing the action plan generated by the action plan generating part 144 is stored in the storage part 180 as the action plan information 184.

FIG. 5 is a diagram illustrating an example of an action plan generated at certain interval. As shown in the drawing, the action plan generating part 144 generates the action plan required by the driving of the own vehicle M in the target lane as shown in the target lane information 183. In addition, the action plan generating part 144 can also dynamically change the action plan according to the condition of the own vehicle M regardless of the target lane information 183. For example, when the velocity of the peripheral vehicles recognized by the outside recognizing part 142 exceeds a threshold value or a moving direction of the peripheral vehicles driven on the lane adjacent to the own lane faces the direction of the own lane, the action plan generating part 144 changes the event of the own vehicle M set at the preset driving interval. For example, if the event is set in a manner of executing the lane change event after the lane keep event, then when it is judged that the vehicle is drives at a velocity larger than the threshold value from a position behind the lane of the lane change target in the lane keep event according to a recognizing result of the outside recognizing part 142, the action plan generating part 144 can also change the next event of the lane keep event to the deceleration event or the lane keep event from the lane change event. As a result, the vehicle control system 100 can automatically drive the own vehicle M safely even if under the condition hat the outside state is changed.

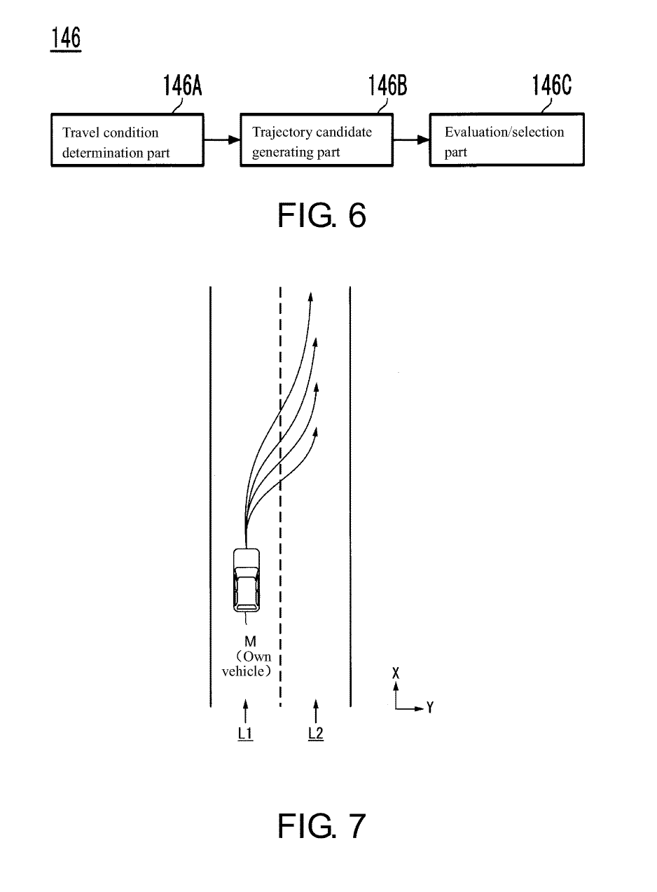

FIG. 6 is a diagram illustrating an example of constitution of a trajectory generation part 146 in a first embodiment. The trajectory generation part 146 for example has a travel condition determination part 146A, a trajectory candidate generating part 146B and an evaluation/selection part 146C.

The travel condition determination part 146A for example decides any travel condition of fixed velocity driving, following driving, low velocity following driving, deceleration driving, curve driving and obstacle avoiding driving during the lane keep event. At this point, the travel condition determination part 146A decides the travel condition to be fixed velocity driving when there are no other vehicles in front of the own vehicle M. Besides, the travel condition determination part 146A decides the travel condition to be following driving when performing following driving is relative to a preceding vehicle. Besides, the travel condition determination part 146A decides the travel condition to be low-velocity following driving during a congestion scenario, etc. Besides, the travel condition determination part 146A decides the travel condition to be fixed deceleration driving when the outside recognizing part 142 recognizes the deceleration of the preceding vehicle or the stopping or parking events are performed. Besides, the travel condition determination part 146A decides the travel condition to be curve driving when the outside recognizing part 142 recognizes that the own vehicle M is close to a curve. Besides, the travel condition determination part 146A decides the travel condition to be obstacle avoiding driving when the outside recognizing part 142 recognizes that there is an obstacle in front of the own vehicle M. Besides, the travel condition determination part 146A decides the travel condition corresponding to each event when executing the lane change event, the overtaking event, the fork event, the converging event, the handover event and the like.

The trajectory candidate generating part 146B generates a trajectory candidate based on the travel condition determined by the travel condition determination part 146A. FIG. 7 is a diagram llustrating an example of a trajectory candidate generated by a trajectory candidate generating part 146B. FIG. 7 expresses the trajectory candidate generated when the own vehicle M changes the lane L1 to the lane L2.

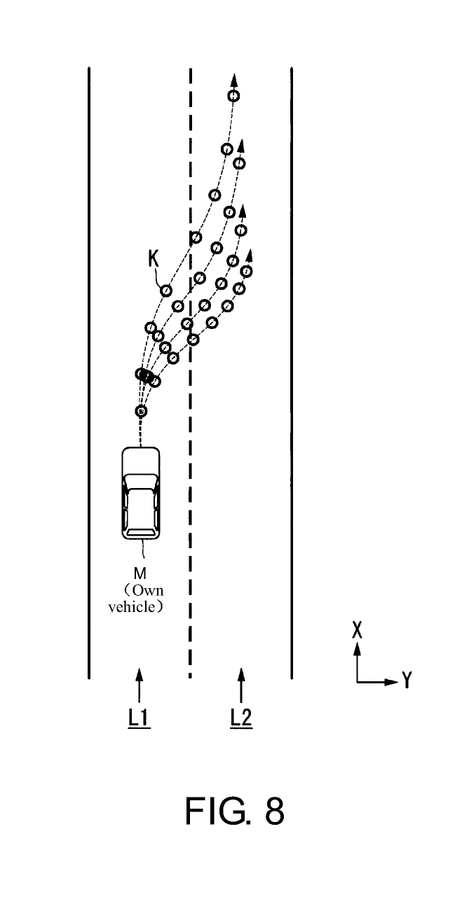

The trajectory candidate generating part 146B decides for example a set of the target position (trajectory point K) that the reference position (for example gravity center or ear wheel axis center) of the own vehicle M should arrive at in each prescribed time in the future to be the trajectory as shown in FIG. 7. FIG. 8 is a diagram illustrating the trajectory candidate generated by the trajectory candidate generating part 146B with a trajectory point K. The winder the interval of the trajectory point K, the faster the velocity of the own vehicle M, and the narrower the interval of the trajectory point K, the slower the velocity of the own vehicle M. Therefore, when the trajectory generation part 146 is about to accelerate, the interval of the trajectory point K is widened gradually, and the interval of the trajectory point is narrowed when the trajectory candidate generating part 146B is about to decelerate.

In this way, since the trajectory point K contains a velocity component, the trajectory candidate generating part 146B must give a target to the trajectory point K. The target velocity is determined by the travel condition determined by the travel condition determination part 146A.

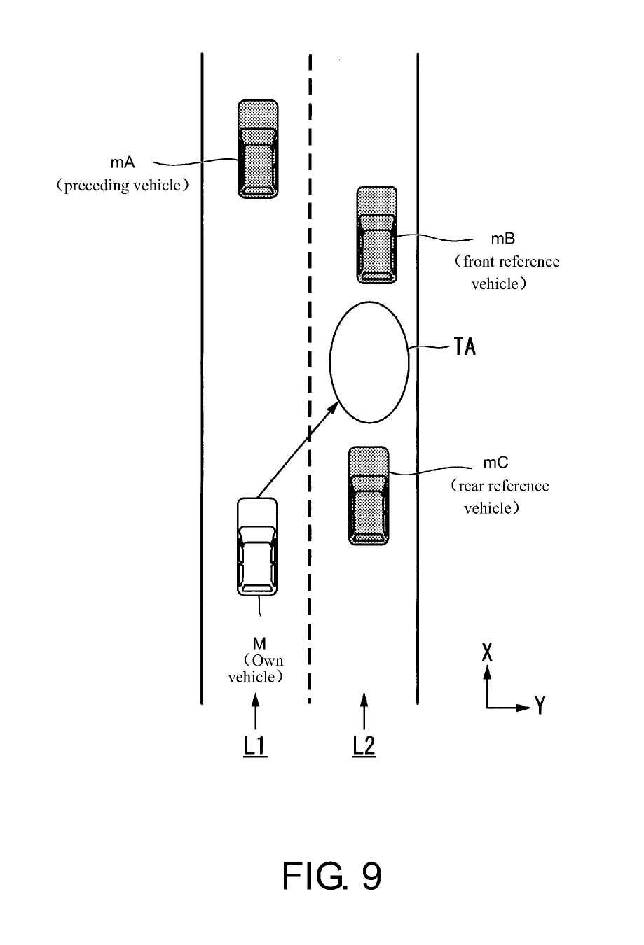

Herein, the method of deciding the target velocity when the lane is changed (containing fork) is explained. The trajectory candidate generating part 146B firstly sets a lane change target position (or converge target position). The lane change target position is set as a relative position of the peripheral vehicles and “the lane is changed between which peripheral vehicles” is determined. The trajectory candidate generating part 146B focuses three peripheral vehicles by taking the lane change target position as a reference and decides the target velocity during lane change. FIG. 9 is a diagram illustrating a lane change target position TA. In the drawing, L1 expresses an own lane, and L2 is an adjacent lane. Herein, in the lane same as the own vehicle M, the peripheral vehicles driven in right front of the own vehicle M are defined as preceding vehicles mA, the peripheral vehicles driven in right front of the lane change target position TA are defined as front reference vehicles mB, and the peripheral vehicles driven right behind the lane change target position TA are defined as rear reference vehicles mC. The vehicle M per must be accelerated and decelerated in order to move to the position aside the lane change target position TA, but at this point, tailgating with the preceding vehicles mA must be avoided. Therefore, the trajectory candidate generating part 146B predicts a future state of three peripheral vehicles and decides the target velocity in a manner of not interfering with the peripheral vehicles.

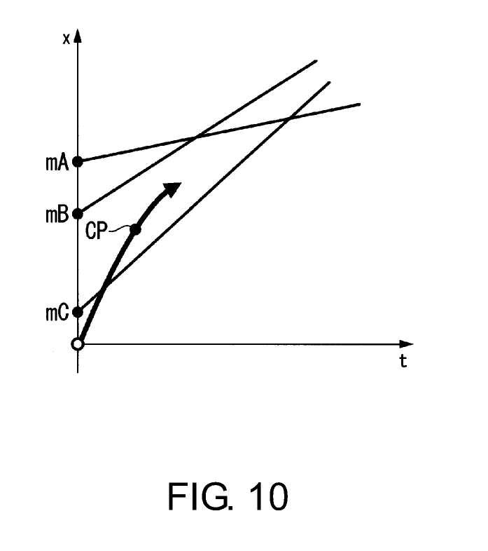

FIG. 10 is a diagram of a velocity generating model when the velocities of three peripheral vehicles are assumed to be fixed. In the drawing, the straight lines from mA, mB and mC express displacements in the advancing direction when each peripheral vehicle is driven at fixed velocity. The own vehicle M is located between the front reference vehicle mB and the rear reference vehicle mC at a point CP that the lane change is finished, and must be located behind the preceding vehicle mA before this. Under such limitation, the trajectory candidate generating part 146B derives multiple time sequence graphs of the target velocity till the lane change is finished. Besides, by applying the time sequence graphs of the target velocity to models such as a spline curve, multiple tract candidates as shown in FIG. 8 can be derived. In addition, motion graphs of the three peripheral vehicles are not limited to the fixed velocity as shown in FIG. 10, and prediction can also be performed by taking a constant velocity and a constant acceleration (jerk) as a premise.

The evaluation/selection part 146C evaluates based on two opinions of planning and safety of the trajectory candidate generated by the trajectory candidate generating part 146B so as to select the trajectory output to the traveling control part 160. According to the planning opinion, for example, if the following feature of the generated plan (for example action plan) is high and the whole length of the trajectory is short, then the trajectory evaluation is high. For example, under the condition of expecting to change the lane rightward, the evaluation on the trajectory of temporarily changing the lane leftward and then returning is low. According to the opinion of safety, for example, in each trajectory point, the farther the distance from the own vehicle M to an object (peripheral vehicles, etc.) is, the smaller the variable of the acceleration and deceleration or rudder angle is, and then the higher the evaluation is.

The changeover control part 150 is switched between the automatic driving mode and the manual driving mode based on the signal and the like input from the automatic driving changeover switch 87. Besides, the changeover control part 150 switches to the manual driving mode from the automatic driving mode based on the indication acceleration, deceleration or steering operation specific to the constitution of the driving operation system in the HMI70. For example, the changeover control part 150 switches to the manual driving mode (override) from the automatic driving mode when the state that an operation quantity shown by the signal input by the constitution of the driving operation system in the HMI70 exceeds a threshold value lasts for more than reference time. Besides, the changeover control part 150 can also restore the automatic driving mode when there is no operation specific to the constitution of the driving operation system in the HMI70 being detected during the prescribed time after the override is switched to the manual driving mode 150.

The traveling control part 160 controls the travel driving force output device 200, the steering device 210 and the brake device 220 to cause the own vehicle M to pass by a trajectory generated by the trajectory generation part 146 according to a preset moment.

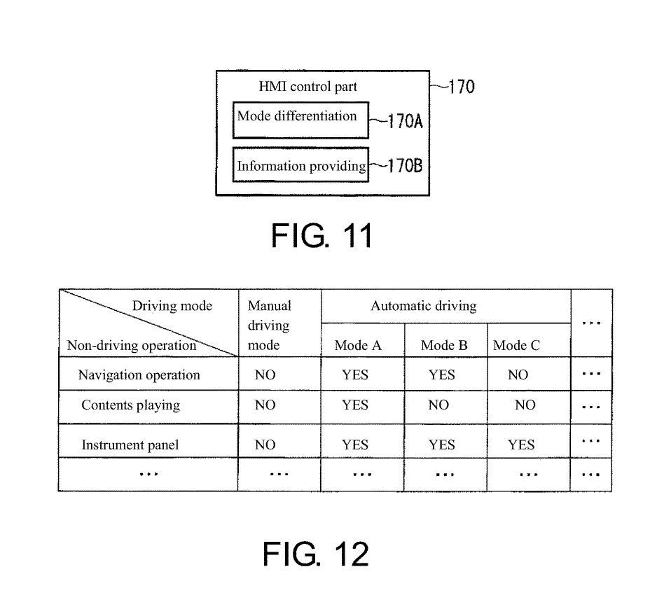

FIG. 11 is a diagram representing a structure of an HMI control part 170. The HMI control part 170 for example has a mode differentiation control part 170A and an information providing part 170B.

The mode differentiation control part 170A controls the control HMI70 according to the variety of the automatic driving mode with reference to the mode differentiation operation yes/no information 185 when the automatic driving control part 120 notifies the automatic driving mode information.

FIG. 12 is a drawing illustrating an example of the mode differentiation operation yes/no information 185. The differentiation operation yes/no information 185 as shown in FIG. 12 has items of “a manual driving mode”, “an automatic driving mode” as items of the driving mode. Besides, as “the automatic driving mode”, there are the “mode A,”, “the mode B”, “the mode C” and the like. Besides, the differentiation operation yes/no information 185 has an operation, i.e., “navigation operation” specific to the navigation device 50, an operation i.e., “content playing operation” specific to the contents playing device 85, an operation, i.e., “instrument panel operation” specific to the display device 82, etc., to serve as items of the non-driving operation system. In the example of the differentiation operation yes/no information 185 as shown in FIG. 12, whether the vehicle passenger operates non-driving operation system or not is set specific to each driving mode, but an interface device of the object is not limited thereto.

The mode differentiation control part 170A judges the devices which are permitted to be used (part or all of the navigation device 50 and the HMI70) and the devices which are not permitted to be used according to the information of mode obtained from automatic driving control part 120. Besides, the mode differentiation control part 170A controls an operation that whether the operation specific to the HMI70 or the navigation device 50 of the non-driving operation system by the vehicle is accepted or not based on a judging result.

For example, when the driving mode executed by the vehicle control system 100 is the manual driving mode, the vehicle passenger operates structures (for example, the accelerator pedal 71, the brake pedal 74, the shift lever 76 and the steering wheel 78) of the driving operation system of the HMI70. Besides, when the driving mode executed by the vehicle control system 100 is the mode B, the mode C and the like of the automatic driving modes, the vehicle passenger has a duty of monitoring the periphery of the own vehicle M. Under such condition, in order to prevent attention distraction (driver destruction) caused by other actions (for example the operation of the HMI70, etc.) except for driving of the vehicle passenger, the mode differentiation control part 170A controls in a manner of not accepting part or all of operations to the non-driving operation system of the HMI70. At this point, the mode differentiation control part 170A can display the existence of the peripheral vehicles of the own vehicle M recognized by the outside recognizing part 142 and a state of the peripheral vehicles on the display device 82 as images, etc., and causes the display device HMI70 to accept a confiuiiiation operation corresponding to a scenario where the own vehicle M is driven.

Besides, when the driving mode of the mode differentiation control part 170A is the automatic driving mode A, the limitation of driver destruction can be loosed, and the control of accepting the operation of the vehicle passenger who does not accept operation specific to the non-driving operation system is performed. For example, the mode differentiation control part 170A causes the display device 82 to display an image or the speaker 83 to output a sound, or causes the contents playing device 85 to play contents from a Digital Video Disc (DVD). In addition, except for the content stored in the DVD, the contents played by the content playing device 85 for example can contain various contents related to amusement and entertainment. Besides, the “contents playing operation” as shown in FIG. 11 means that the contents operation can be related to such amusement and entertainment.

The information providing part 170B, based on the judging result of the energy monitoring part 190 mentioned later, uses the display device 82 or speaker 83 of the HMI70 to inform the vehicle passenger of various information. The informed information is mentioned below in detail.

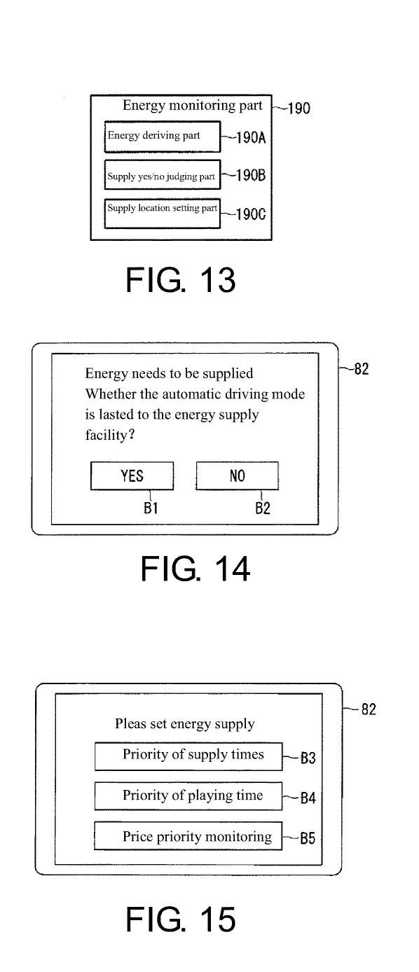

FIG. 13 is a diagram representing a structure of an energy monitoring part 190. The energy monitoring part 190 for example has an energy deriving part 190A, a supply yes/no judging part 190B and a supply location setting part 190C.

The energy deriving part 190A derives the energy predicted to be consumed in the future till the own vehicle M arrives at the destination based on the guide path information 182 output from navigation device 50. For example, the energy deriving part 190A assumes that during the period from the current position to the destination, the own vehicle M is driven at a velocity taking a legal velocity or average velocity of the road shown by the guide path, and the energy consumed by the own vehicle M during such period is derived to be the energy predicted to be consumed. Besides, the energy deriving part 190A for example can also derive the energy predicted to be consumed in the future by using an index obtained by dividing the energy consumed in the past by a unit time or unit distance. Besides, the energy deriving part 190A can also derive the energy predicted to be consumed by considering time till a congestion or accident is eliminated when judging that the congestion or accident occurs on the road shown by the guide path with reference to the traffic information obtained by the communication device 55.

The supply yes/no judging part 190B judges whether the energy needs to be supplied till the own vehicle M arrives at the destination based on the energy residue and the energy predicted to be consumed calculated by the energy residue calculating part 95. For example, the supply yes/no judging part 190B judges that the energy needs to be supplied under the condition that the energy residue and the energy predicted to be consumed have the same degree or under the condition that the energy predicted to be consumed is larger than the energy residue. Hereinafter, the moment when the energy residue and the energy predicted to be consumed reach the same degree or the moment when the energy predicted to be consumed is larger than the energy residue is called as a traveling extreme location P_{LIM} for explanation.

When the supply yes/no setting part 190B judges that the energy needs to be supplied, the supply location setting part 190C judges whether a plurality of energy supply facilities exist around the guide path to the driving extreme location P_{LIM} by referring to the guide path information 182, and sets the energy supply facility capable of supplying energy at a moment favoured by the vehicle passenger into a temporary destination (short emporary destination hereinafter) if the energy supply facilities exist around the guide path. In addition, if only one energy supply facility exists around the guide path, then the supply location setting part 190C can set such energy supply facility into the temporary destination. Besides, if there is no energy supply facility around the guide path to the driving extreme location P_{LIM}, then the supply location setting part 190C notifies that the action plan generating part 144 or the trajectory generation part 146 must stop the own vehicle M. After the notification is received, the current event is changed to an event of stopping the own vehicle M by the action plan generating part 144 or the trajectory generation part 146 generate a trajectory of gradually narrowing a configuration interval of a trajectory point K to stop the own vehicle M. Therefore, under the condition of insufficient energy for driving, the own vehicle M can be safely stopped by automatic driving.

The information providing part 170B in the HMI control part 170 uses the display device 82 or speaker 83 to inform the vehicle passenger of prescribed information when the supply yes/no judging part 190B judges that the energy needs to be supplied. The so-called prescribed information for example is information used for causing the vehicle passenger to know that the energy needs to be supplied.

FIG. 14 is a diagram of an example of a screen displayed under a scenario that the energy needs to be supplied. As shown in the drawing, on a screen of the display device 82, words or images and the like for informing that the energy needs to be supplied are displayed. Besides, as shown in the drawing, a selection button is displayed on such screen, and is used for selecting whether the automatic driving mode is lasted to the energy supply facility or not. For example, when a button B1 lasting the automatic driving mode is selected by the touch operation, then the automatic driving mode is peiniitted, and when a button B2 stopping the automatic driving mode is selected by the touch operation, the lasting of the automatic driving mode is stopped. When the button B2 is selected, the changeover control part 150 switches the driving mode from the automatic driving mode to the manual driving mode.

Besides, the infoiniation providing part 170B displays the following screen on the display device 82 when permitting to last the automatic driving mode in order for energy supply, and the screen is a condition designated for deciding an energy supply moment.

FIG. 15 is a diagram illustrating an example of a screen displayed when an automatic driving mode is permitted to last in order for energy supply. On the screen, a condition used for deciding the energy supply moment is selected. As shown in the drawing, for example, on the screen of the display device 82, a button B3 selecting a priority condition of supply times, a button B4 selecting a priority condition of content playing time, and a button B56 selecting a priority condition of price are displayed. The so-called priority condition of supply times is a condition that the supply times in the automatic driving process are as less as possible, besides, the priority condition of content playing time is a condition that executing time of the mode A needing no periphery monitoring is prolonged to ensure the content playing time on priority. Besides, the so-called price priority condition is a condition that the energy supply facility with a lowest price for energy supply is set into the temporary destination on priority. In addition, the screen as shown in FIG. 15 can be displayed when energy needs to be supplied in the automatic driving mode, and can also be displayed when the manual driving mode before the automatic driving mode is converted, or the passenger sits in the own vehicle M, when the own vehicle M is stopped, and the like.

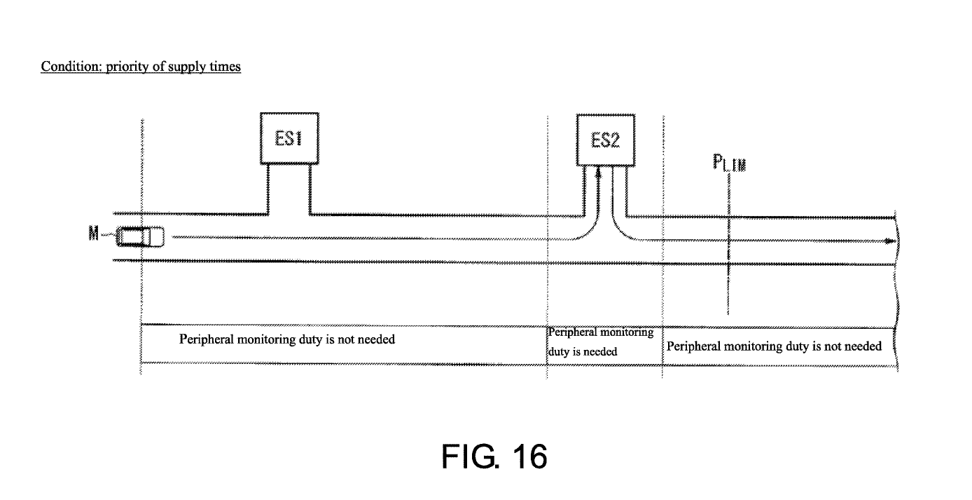

On the screen as shown in FIG. 15, for example, when the button B3 is selected, the supply location setting part 190C sets the energy supply facility with the least supply times into the temporary destination. FIG. 16 is a diagram for explaining a setting method of a temporary destination for meeting a priority condition of supply times. ES1 and ES2 in the drawing represent energy supply facilities. Besides, P_{LIM} represents the driving extreme location. The supply location setting part 190C sets the energy supply facility around the guide path (along the guide path) from the current position of the own vehicle M to the driving extreme location P_{LIM} in the multiple energy supply facilities and located in front of the driving extreme location P_{LIM} and closest to the driving extreme location P_{LIM} into the temporary destination. Under the condition as shown in the drawing, since the energy supply facility ES2 is closer to the driving extreme location P_{LIM} than the energy supply facility ES1, the energy supply facility ES2 is set into the temporary destination. Therefore, the vehicle control system 100 can consume energy as much as possible to drive the own vehicle M. As a result, the vehicle control system 100 can shorten time required for energy supply, and therefore, the vehicle M can arrive at the destination faster.

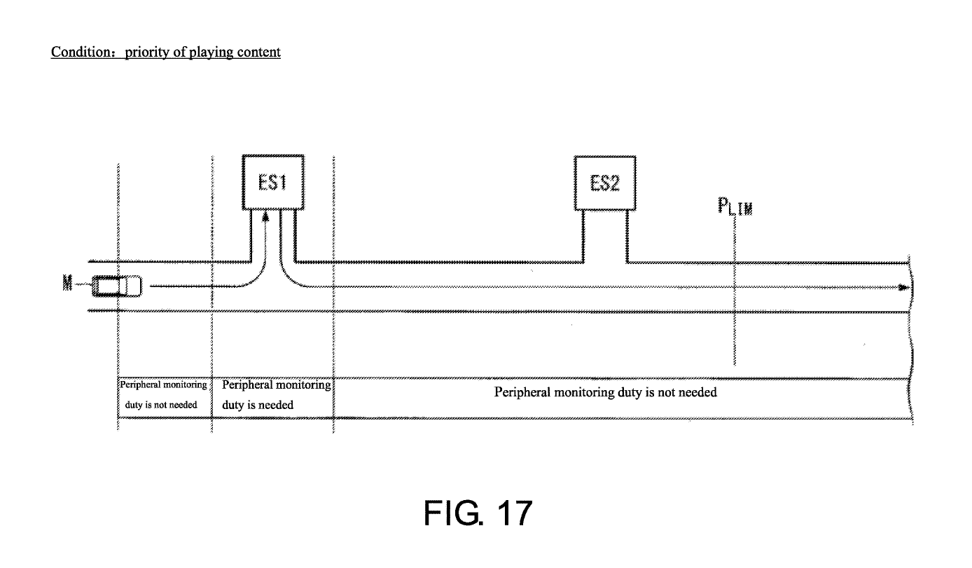

Besides, on the screen as shown in FIG. 15, for example, when the button B4 is selected, the supply location setting part 190C can set the energy supply facility into the temporary destination in a manner that the content playing time is the longest after energy supply. FIG. 17 is a diagram for explaining a setting method of a temporary destination for meeting a priority condition of playing time. The supply location setting part 190C sets the energy supply facility around the guide path (along the guide path) from the current position of the own vehicle M to the driving extreme location P_{LIM} in the multiple energy supply facilities and closest to the current position of the own vehicle M into the temporary destination. Under the condition as shown in the drawing, the energy supply facility ES1 is closer to the current position of the own vehicle M than the energy supply facility ES1, such that the energy supply facility ES1 is set into the temporary destination. Therefore, the vehicle control system 100 is kept in the mode A without a need of the periphery monitoring duty for long time after energy supply. As a result, the vehicle control system 100 can last the content playing a television program and the like and convenience is brought to the vehicle passenger.

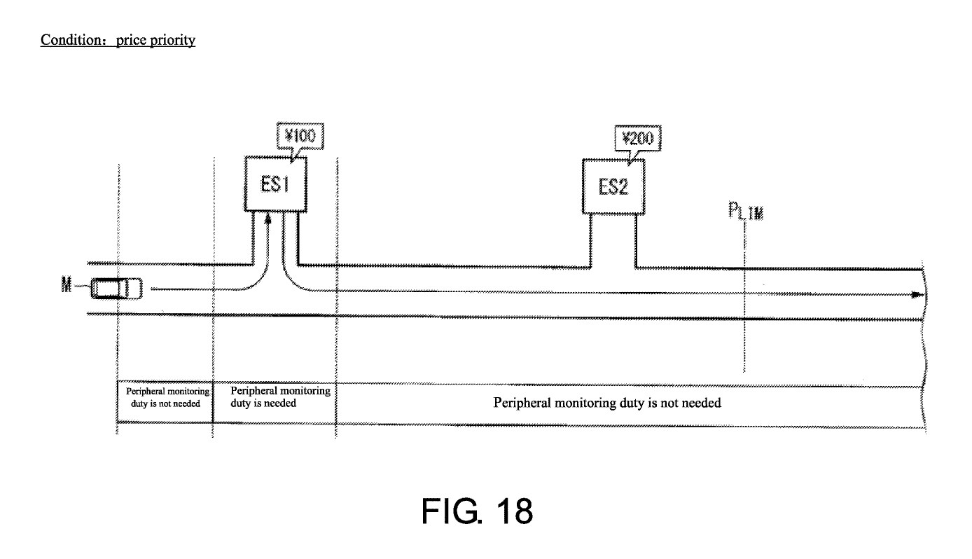

Besides, on the screen as shown in FIG. 15, when the button B5 is selected, the supply location setting part 190C sets the energy supply facility with the lowest energy supply price into the temporary destination by referring to the information related to energy price received by the communication device 55. FIG. 18 is a diagram for explaining a setting method of a temporary destination for meeting a priority condition of price. The supply location setting part 190C sets the energy supply facility around the guide path (along the guide path) from the current position of the own vehicle M to the driving extreme location P_{LIM} in the multiple energy supply facilities and having the lowest energy supply price into the temporary destination. Under the condition as shown in the drawing, since the energy supply facility ES2 is lower than the energy supply facility ES1 in energy supply price, the energy supply facility ES1 is set into the temporary destination.

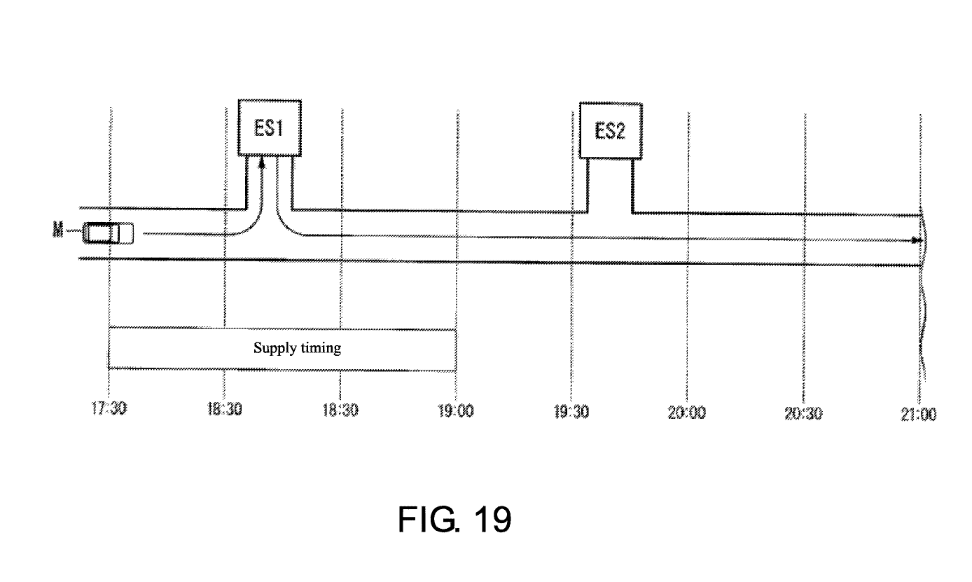

Besides, the information providing part 170B can cause the display device 82 to display a screen designating an energy supply moment corresponding to each moment or distance. FIG. 19 is a diagram for explaining a setting method of a temporary destination corresponding to an energy supply moment designated at each moment. For example, when the vehicle passenger wants to view a television program after 19 o'clock, as shown in FIG. 19, the moment is designated in a manner of energy supply before 19 o'clock. At this point, the supply location setting part 190C sets the energy supply facility along a predicted guide from the current moment to a designated moment into the temporary destination. Under the condition as shown in the drawing, the energy supply facility ES1 is set into the temporary destination. As a result, the vehicle control system 100 can finish the energy supply before the designated moment and the mode A is executed after the designated moment to play the television program without interruption.

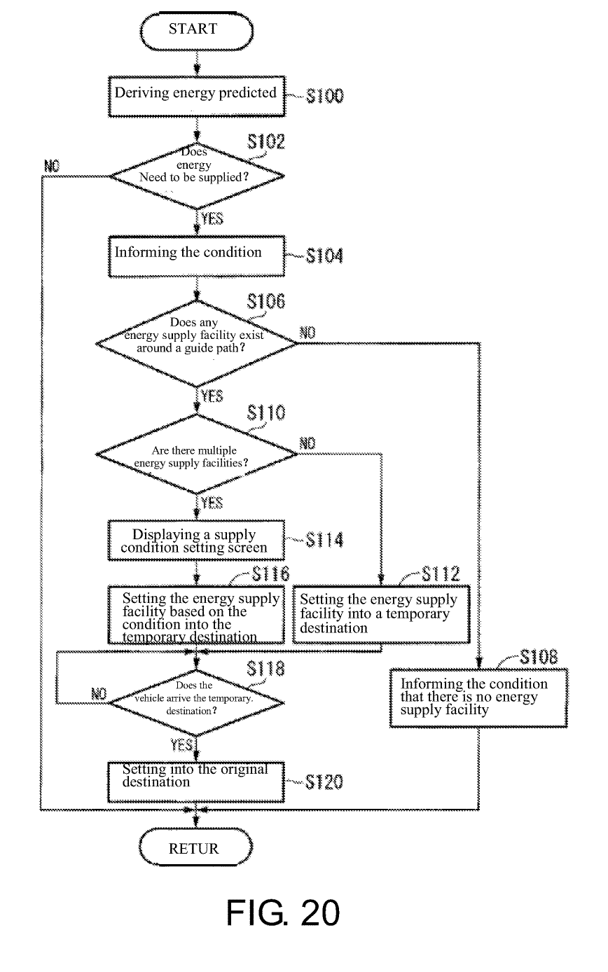

FIG. 20 is a flow chart illustrating an example of a flow of processing performed by a vehicle control system 100 in the first embodiment. At first, the energy deriving part 190A derives the energy predicted to be consumed till the own vehicle M arrives at the destination based on the guide path infoiiiiation 182 output from the navigation device 50 (step S100).

Next, the supply yes/no judging part 190B judges whether the energy needs to be supplied till the vehicle M arrives at the destination based on the energy residue calculated by the energy residue calculating part 95 and the energy predicted to be consumed (step S102). If the energy does not need to be supplied, then the processing in the flow chart is ended by the supply yes/no judging part 190B.

On another aspect, if the energy needs to be supplied, then the information providing part 170B uses the display device 82 or speaker 83 of the HMI70 to inform the vehicle passenger the condition that the energy needs to be supplied (step S104). Next, the supply location setting part 190C judges whether the energy supply facility exists around the guide path to the driving extreme location P_{LIM} (step S106). If there is no energy supply facility around the guide path, then the information providing part 170B informs the vehicle passenger of the condition that there is no way to supply energy caused by no energy supply facility (step S108). At this point, if there is no energy supply facility around the guide path to the driving extreme location P_{LIM}, then the supply location setting part 190C informs the action plan generating part 144 or trajectory generation part 146 of stopping the own vehicle M. Therefore, the action plan generating part 144 changes the executed event into the event of stopping the own vehicle M, or the trajectory generation part 146 generates a trajectory of gradually narrowing a configuration interval of a trajectory point to decelerate and stop the own vehicle M, therefore, the own vehicle M is stopped automatically.

On another aspect, if there are multiple energy supply facilities around the guide path, then the supply locations setting part 190C judges whether there are multiple energy supply facilities (step S110). If there are no multiple energy supply facilities, then the supply location setting part 190C sets this one energy supply facility into the temporary destination (step S112).

On another aspect, if there are multiple energy supply facilities, then the infoiiiiation providing part 170B uses the display device 82 to display the following screen, which is used for designating a condition for deciding an energy supply moment (step S114). The supply location setting part 190C sets the energy supply facility meeting the designated condition in the energy supply facilities into the temporary destination (step S116). For example, when the vehicle M arrives nearby the energy supply facility as the temporary destination, the trajectory generation part 146 generates the trajectory mentioned below, that is, the own vehicle M is guided into the energy supply facility from a current lane where the own vehicle M is driven, and the own vehicle M is stopped in a prescribed position in the energy supply facility.

Next. The supply location setting part 190C is standby till the own vehicle M arrives at the destination (step S118). When the energy supply is finished after the own vehicle M arrives at the temporary destination, the temporary destination is set into the original destination (step S120). At this point, for example, the trajectory generation part 146 generates a trajectory causing the own vehicle to be converged to an original lane from the energy supply facility. Therefore, the processing in this flow chart is ended.

According to the first embodiment explained as above, the energy predicted to be consumed during automatic driving on the guide path from the current position of the own vehicle M to the set destination is derived, based on the derived energy, whether the energy needs to be supplied till the own vehicle M arrives at the destination is judged, therefore, the timing of energy supply can be derived in the automatic driving process with a better precision.

### Second Embodiment

A second embodiment is explained hereinafter. In the second embodiment, the difference from the first embodiment is that relative to any automatic driving mode, there are multiple modes with different energy consumptions (called as burnup mode). Hereinafter, related differences are taken as a center for explanation.

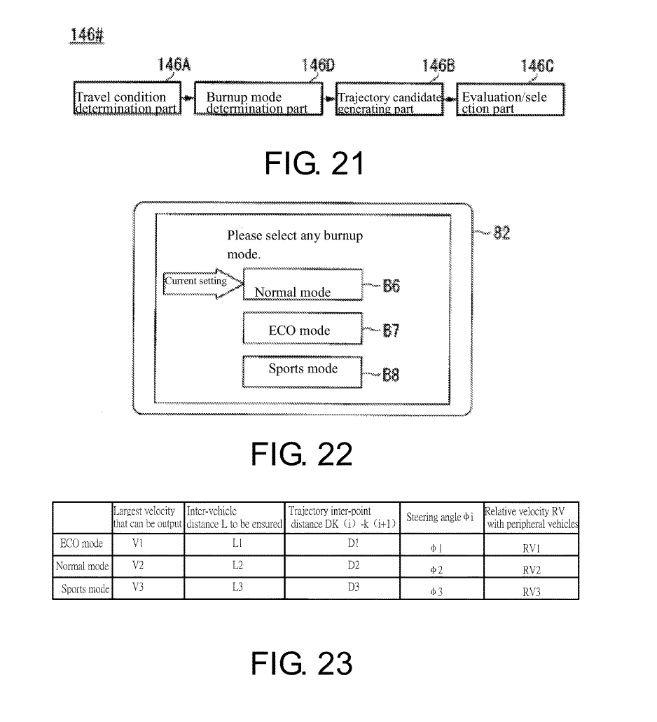

FIG. 21 is a diagram of an example of a structure of a trajectory generation part 146# in a second embodiment. The trajectory generation part 146# in the second embodiment also has a burnup mode determination part 146D except for the driving mode determination part 146A, the trajectory candidate generating part 146B and the evaluation/selection part 146C.

The burnup mode determination part 146D for example selects any one of burnup modes such as an Economy (ECO) mode with a best burnup efficiency, a no nal mode with a burnup efficiency second to the ECO mode, a sports mode with a burnup efficiency second to the normal mode, and the like.

FIG. 22 is a diagram illustrating selection of an example of a screen of a burnup mode. Such screen is displayed by using the display device 82 through the communication providing part 170B. As shown in the drawing, on the screen, a button B6 setting the burnup mode into the ECO mode, a button B7 setting the burnup mode into the normal mode and a button B8 setting the burnup mode into the sports mode are displayed. The burnup mode determination part 146D decides the burnup mode into a mode corresponding to the button operation of the screen. In these burnup modes, various condition conditions are set in order to limit energy consumption.

FIG. 23 is a diagram illustrating an example of a control condition of each burnup mode. As shown in the drawing, in the burnup mode, the control conditions of a largest velocity V that can be output by the own vehicle M, a shortest inter-vehicle distance L from a preceding vehicle, a trajectory inter-point distance D_{K(i)-K(i+1)} equivalent to the interval of the trajectory point K, a steering angle φi, a relative velocity VR with the peripheral vehicles that should be considered exist.

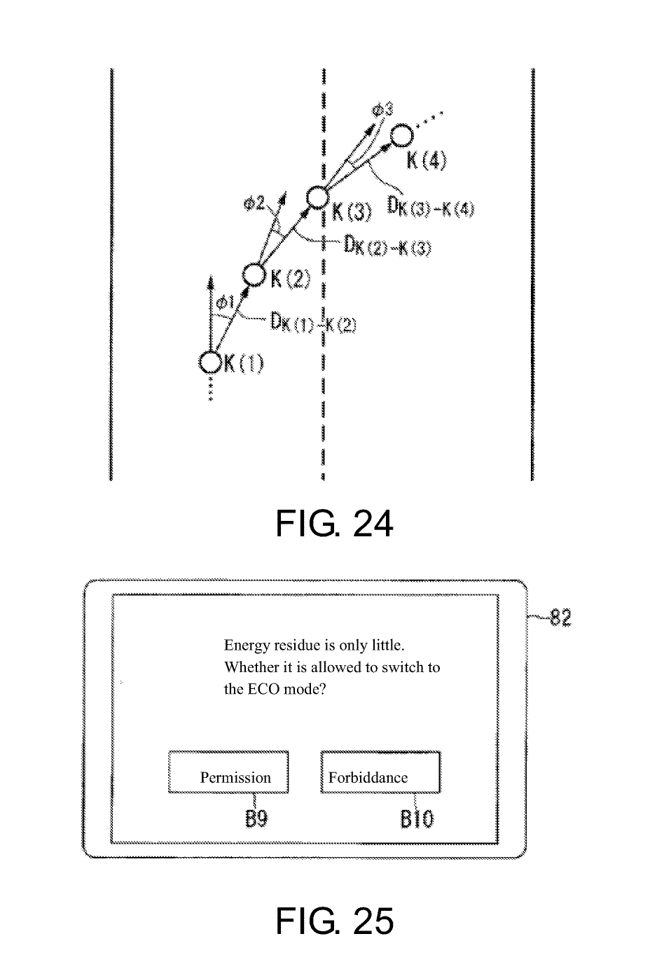

FIG. 24 is a diagram for explaining a trajectory inter-point distance D_{K(i)-K(i+1)} and a steering angle φi. The trajectory inter-point distance D_{K(i)-K(i+1)} as shown in the drawing is the distance between a trajectory K(i) and a K(i+1), and the trajectory point K(i+1) is a prescribed target position where the own vehicle M arrives from the trajectory point K(i). The trajectory point K(i) contains a component of the steering angle φi for the own vehicle M to advance relative to a direction where the trajectory point K(i+1) is, and the trajectory point K(i+1) is the prescribed target position where the own vehicle M arrives from the trajectory point K(i). The steering angle φi for example is an angle formed between an axle direction of the own vehicle M on the trajectory point K(i) and a direction where the trajectory point K(i+1) to be reached next when the trajectory point K(i) is taken as a standard. The traveling control part 160 for example decides a trajectory inter-point velocity for example according to the trajectory inter-point distance D_{K(i)-K(i+1)} and the preset arriving moment of each trajectory point K and decides a control quantity of the driving power output device 200 and the brake device 220 based according to the velocity. Besides, the traveling control part 160 for example decides a rudder angle based on information such as a corresponding steering angle φi corresponding to each trajectory point K(i) or a vehicle velocity (or acceleration or jerkiness) obtained from the vehicle sensor 60, an angular velocity (deflection angular velocity) around a plum axis, and the like, so as to decide a control quantity of the electromotor in the steering device 210 in a manner of giving a displacement of the rudder angle to wheels.

For example, when the burnup mode is the ECO mode, compared with a normal mode, the largest velocity is smaller, accordingly, the available trajectory inter-point distance D_{K(i)-K(i+1)} is shorter. Besides, the inter-vehicle distance L is narrower, and the steering angle φi and relative velocity RV are also smaller. Therefore, the action of the own vehicle M in the ECO mode is slower than that of the own vehicle M in the normal mode. For example, the vehicle control system 100 automatically drives the own vehicle M in a manner that the own vehicle M in the ECO mode does not exceed the preceding vehicle in the normal mode and follows the preceding vehicle. As a result, in the ECO mode, the acute acceleration, deceleration or steering is inhibited, thereby inhibiting the energy consumption. On the other hand, when the burnup mode is the sports mode, compared with the normal mode, the largest velocity is larger, accordingly, the available trajectory inter-point distance D_{K(i)-K(i+)} is longer. Besides, the inter-vehicle distance L is wider, and the steering angle φi and relative velocity RV are also larger. The action of the own vehicle M in the sports mode is agiler than that of the own vehicle M in the normal mode. As a result, although consumed energy is easily increased, under the condition that the relative velocity RV with the peripheral vehicles is smaller, lane change or overtaking can still be performed, such that the own vehicle M arrives at the destination faster. In addition, when the burnup mode is the ECO mode, in order to inhibit energy consumption, the burnup mode determination part 146D can limit the use of the non-driving operation system of the display device 82 or the air conditioner device 93 and the HMI70.

The energy deriving part 190A in the second embodiment derives the energy predicted to be consumed till the own vehicle M arrives at the destination under the condition of keeping the currently executed burnup mode. At this point, when the supply yes/no judging part 190B judges that the energy needs to be supplied in order to keep the currently executed burnup mode, the energy deriving part 190A changes into the burnup mode in which the energy consumption is less than the currently executed burnup mode, and derives the energy predicted to be consumed till the own vehicle M arrives at the destination under the condition of keeping the burnup mode of better burnup. The energy predicted to be consumed under the state of keeping the burnup mode of better burnup is one example of “energy during burnup inhibition”.

The supply yes/no judging part 190B further judges whether the energy needs to be supplied till the own vehicle M arrives at the destination based on the energy predicted to be consumed during the burnup mode with better burnup. For example, when the currently executed burnup mode is the sports mode, the supply yes/no judging part 190B judges whether energy needs to be supplied assuming that the normal mode or ECO mode is lasted if the energy needs to be supplied in the sports mode. The normal mode or ECO mode at this point is one example of “burnup inhibition mode”.

The information providing part 170B uses the display device 82 to display the following screen, which is used for obtaining a permission of changing the currently executed burning mode into the burnup mode with better burnup when the energy needs to be supplied when the current executed burnup mode is lasted but the energy does not need to be supplied when the not changed into the burnup mode with better burnup.

FIG. 25 is a diagram illustrating an example of a screen for requesting to permit to change the burnup mode. As shown in the drawing, on the screen, a B9 permitting to change the burnup mode and a button B10 forbidding to change the burnup mode are displayed. For example, when the button B9 is selected for touch operation, the burnup mode determination part 146D changes the currently burnup mode into a mode with better burnup. On another aspect, when the button B10 is selected for touch operation, the burnup mode determination part 140D keeps the current burnup mode.

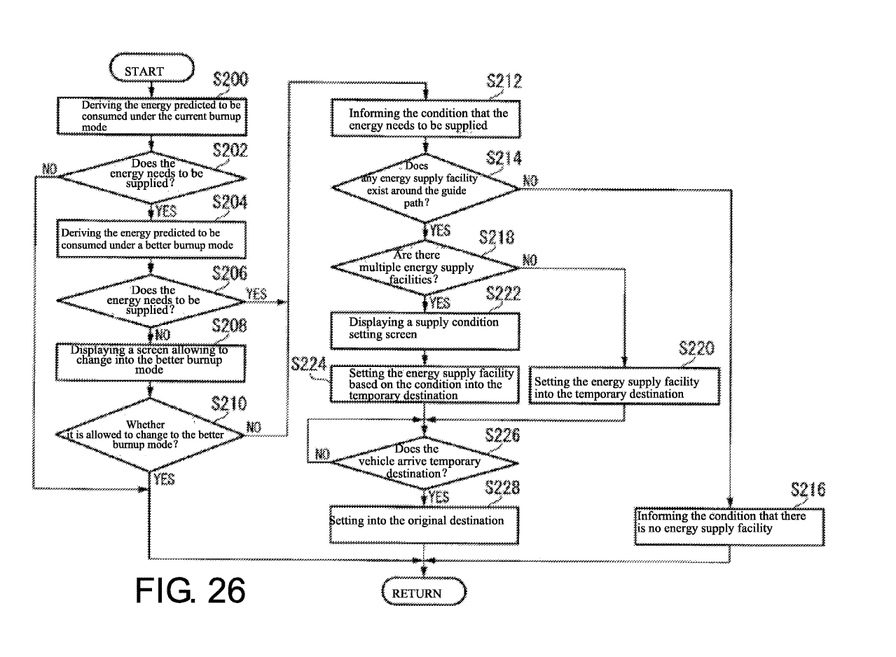

FIG. 26 is a flow chart illustrating an example of a flow of processing performed by a vehicle control system 100 in a second first embodiment. The series of processing of S212 to S218 in this flow chart and the processing in the flow chart in FIG. 20 are in the same structure.

At first, the energy deriving part 109A derives the energy predicted to be consumed till the own vehicle M arrives at the destination under the condition of keeping the currently executed burnup mode (S200). Next, the supply yes/no judging part 190B judges the energy needs to be supplied (S202). If the energy does not need to be supplied, then the supply yes/no judging part 190B ends the processing in this flow chart.

On another aspect, if the energy needs to be supplied, then the energy deriving part 190A derives the energy predicted to be consumed till the own vehicle M under the condition of changing into the burnup mode in which the energy consumption is less that of the currently executed burnup mode (S204).

Next, the supply yes/no judging part 190B judges whether the energy needs to be supplied under the condition of keeping the better burnup mode (S206). If the energy to be supplied under the condition of keeping the better burnup mode, then the supply yes/no judging part 190B moves the processing to S212.

On another aspect, if the energy does not need to be supplied in order to keep the better burnup mode, then the information providing part 170B uses the display device 82 to display a screen requesting and permitting to change into the better bumup mode (S208). Next, the burnup mode determination part 146D judges whether it is permitted to change into the better burnup mode (S210), if it is permitted to change into the better burnup mode, then the current burnup mode is changed to the better burnup mode, and the processing in this flow chart is ended.

On another aspect, if it is not permitted to change into the better burnup mode, then the supply yes/no judging part 190B keeps the current burnup mode, and moves the processing to S212. In addition, when the step S202 judges that the energy needs to be supplied, if the currently executed burnup mode is the ECO mode with the best burnup, then the supply yes/no judging part 190B moves the processing to S212.

As processing of S212, the information providing part 170B uses the display device 82 or speaker 83 of the HMI 70 to inform the vehicle passenger of the condition that the energy needs to be supplied (S212). Next, the supply location setting part 190C judges whether there is the energy supply facility around the guide path to the driving extreme location P_{LIM} with reference to the guide path information 182 (S214). If there is no energy supply facility around the guide path, then the information providing part 170B informs the vehicle passenger of the condition that the energy cannot be supplied caused by no energy supply facility (S216). At this point, if there is no one energy supply facility around the guide path to the driving extreme location P_{LIM}, then the supply location setting part 190C can inform that action plan generating part 144 or the trajectory generation part 146 must stop the own vehicle M.

On another aspect, if there are multiple energy supply facilities, then the information providing part 170B uses the display device 82 to display the following screen, which is used for designating a condition deciding an energy supply moment (S222). Next, the supply location setting part 190C sets the energy supply facility meeting the designated condition in the multiple energy supply facilities into the temporary destination (S224).

Next, the supply location setting part 190C sets the temporary destination into the original destination (S228) when the own vehicle M arrives at the destination and energy supply is finished till the own vehicle M arrives at the destination (S226). Therefore, the processing in this flow chart is ended.

According to the second embodiment explained above, similar to the first embodiment, the timing of energy supply in the automatic driving process is derived with a better precision.

The above uses the embodiments to explain a form of implementing the present invention, but the present invention is not limited to the present embodiment in any form, and can be subjected to various transformations and substitutions in a range of not departing from the principle of the present invention.

What is claimed is:

1. A vehicle control system, comprising
an automatic driving control part, automatically performing at least one of velocity control and steering control of a vehicle, thereby automatically driving the vehicle to a set destination;
a deriving part, deriving energy predicted to be consumed during automatic driving on a guide path from a current position of the vehicle to the destination; and
a judging part, judging whether the vehicle needs to be supplied with energy until the vehicle arrives at the destination based on the energy derived by the deriving part.

2. The vehicle control system according to claim 1, further comprising:
an information providing part, providing information for a vehicle passenger when the judging part judges that the vehicle needs to be supplied with energy.

3. The vehicle control system according to claim 1, wherein
the automatic driving control part executes one of multiple modes in which the energy consumptions of the vehicle are different so as to automatically perform at least one of the velocity control and steering control of the vehicle, and executing a burnup inhibition mode in which the energy consumption is less than that of the mode being executed in the multiple modes when the judging part judges that the vehicle needs to be supplied with energy.

4. The vehicle control system according to claim 2, wherein
the automatic driving control part executes one of multiple modes in which the energy consumptions of the vehicle are different so as to automatically perform at least one of the velocity control and steering control of the vehicle, and executing a burnup inhibition mode in which the energy consumption is less than that of the mode being executed in the multiple modes when the judging part judges that the vehicle needs to be supplied with energy.

5. The vehicle control system according to claim 3, wherein
the deriving part derives the energy predicted to be consumed during burnup inhibition when the automatic driving control part executes the burnup inhibition mode, and
the judging part further judges whether the vehicle needs to be supplied with energy based on the energy during burnup inhibition derived from the deriving part.

6. The vehicle control system according to claim 4, wherein
the deriving part derives the energy predicted to be consumed during burnup inhibition when the automatic driving control part executes the burnup inhibition mode, and
the judging part further judges whether the vehicle needs to be supplied with energy based on the energy during burnup inhibition derived from the deriving part.

7. The vehicle control system according to claim 3, wherein
when the judging part judges that the vehicle needs to be supplied with energy, the information providing part provides the information permitting to change the mode executed by the automatic driving control part into the burnup inhibition mode to the vehicle passenger, and
the automatic driving control part changes the executed mode into the burnup inhibition mode when the vehicle passenger permits to change into the burnup inhibition mode.

8. The vehicle control system according to claim 4, wherein
when the judging part judges that the vehicle needs to be supplied with energy, the information providing part provides the information permitting to change the mode executed by the automatic driving control part into the burnup inhibition mode to the vehicle passenger, and
the automatic driving control part changes the executed mode into the burnup inhibition mode when the vehicle passenger permits to change into the burnup inhibition mode.

9. The vehicle control system according to claim 5, wherein
when the judging part judges that the vehicle needs to be supplied with energy, the information providing part provides the information permitting to change the mode executed by the automatic driving control part into the burnup inhibition mode to the vehicle passenger, and
the automatic driving control part changes the executed mode into the burnup inhibition mode when the vehicle passenger permits to change into the burnup inhibition mode.

10. The vehicle control system according to claim 6, wherein
when the judging part judges that the vehicle needs to be supplied with energy, the information providing part provides the information permitting to change the mode executed by the automatic driving control part into the burnup inhibition mode to the vehicle passenger, and
the automatic driving control part changes the executed mode into the burnup inhibition mode when the vehicle passenger permits to change into the burnup inhibition mode.

11. The vehicle control system according to claim 1, further comprising:
a setting part, setting a location where an energy supply facility exists into a temporary destination when the judging part judges that the vehicle needs to be supplied with energy, and
the automatic driving control part causes the vehicle to automatically driving to the destination set by the setting part.

12. The vehicle control system according to claim 2, further comprising:
a setting part, setting a location where an energy supply facility exists into a temporary destination when the judging part judges that the vehicle needs to be supplied with energy, and
the automatic driving control part causes the vehicle to automatically driving to the destination set by the setting part.

13. The vehicle control system according to claim 11, further comprising:
an operation part, operated by the vehicle passenger, and
the setting part decides a priority condition setting the temporary destination on priority based on an operation on the operation part, and sets the energy supply facility meeting the determined priority condition into the temporary destination.

14. The vehicle control system according to claim 12, further comprising:
an operation part, operated by the vehicle passenger, and
the setting part decides a priority condition setting the temporary destination on priority based on an operation on the operation part, and sets the energy supply facility meeting the determined priority condition into the temporary destination.

15. The vehicle control system according to claim 12, wherein
when the information providing part provides prescribed information for the vehicle passenger if no energy supply facility exists around the guide path when the judging part judges that the vehicle needs to be supplied with energy.

16. The vehicle control system according to claim 14, wherein
when the information providing part provides prescribed information for the vehicle passenger if no energy supply facility exists around the guide path when the judging part judges that the vehicle needs to be supplied with energy.

17. A vehicle control method, by which a vehicle-mounted computer:
automatically performs at least one of velocity control and steering control of a vehicle, thereby automatically driving the vehicle to a set destination,
derives the energy predicted to be consumed during automatic driving on a guide path from a current position of the vehicle to the destination, and
judges whether the vehicle needs to be supplied with energy until the vehicle arrives at the destination based on the derived energy.

18. A vehicle control program,
enabling a vehicle-mounted computer to perform following processing:
automatically performing at least one of velocity control and steering control of a vehicle, thereby automatically driving the vehicle to a set destination;
deriving the energy predicted to be consumed during automatic driving on a guide path from a current position of the vehicle to the destination; and
judging whether the vehicle needs to be supplied with energy until the vehicle arrives at the destination based on the energy derived by the deriving part.
